(19) United States
(12) Patent Application Publication
(10) Pub. No.: US 2023/0210100 A1
(43) Pub. Date: Jul. 6, 2023

(54) Fishing Leader Device and Method of Use Thereof

(71) Applicant: Robert Lopez, Dixon, CA (US)

(72) Inventor: Robert Lopez, Dixon, CA (US)

(21) Appl. No.: 18/146,595

(22) Filed: Dec. 27, 2022

Related U.S. Application Data
(60) Provisional application No. 63/294,926, filed on Dec. 30, 2021.

(51) Int. Cl. A01K 91/14; A01K 95/00; A01K 91/047

(52) U.S. Cl. CPC A01K 91/14; A01K 95/00; A01K 91/047

(57) ABSTRACT

The present invention relates to a fishing leader device comprised of a line, at least one hook, at least one weight, and at least one leader attachment member. The weight is positioned at the bottom of the leader above the hook to allow the hook and the leader to be pulled downward toward the bottom of a body of water to prevent tangles and snags. The device is also comprised of at least one bead that can attract fish, as well as protect the connection members from fish biting which can weaken the fastening.

### CROSS-REFERENCE TO RELATED APPLICATION

The present application claims priority to, and the benefit of, U.S. Provisional Application No. 63/294,926, which was filed on Dec. 30, 2021, and is incorporated herein by reference in its entirety.

### FIELD OF THE INVENTION

The present invention relates generally to the field of a fishing equipment. More specifically, the present invention relates to a fishing leader device comprised of a line, at least one hook, at least one weight, and at least one leader attachment member. The weight is positioned at the bottom of the leader above the hook to allow the hook and the leader to be pulled downward toward the bottom of a body of water to prevent tangles and snags. The device is also comprised of at least one bead that can attract fish, as well as protect the connection members from fish biting, which can weaken the fastening. Accordingly, the present disclosure makes specific reference thereto. Nonetheless, it is to be appreciated that aspects of the present invention are also equally applicable to other like applications, devices, and methods of manufacture.

### BACKGROUND

Fishing can require immense skill and knowledge regarding how each different piece of fishing equipment is used. Specifically, a fishing leader is a piece of fishing equipment commonly used to help eliminate the tangling/snagging of fishing lines, which can lead to line breaks. This requires fishermen to reline their pole, which can take long amounts of time. Fishing leaders help lower the probability that the fishing line will break due to the line becoming tangled or snagged.

Further, there are different methods of fishing for different species of fish. By way of example, some species of fish need the bait to be weighted toward the bottom of a body of water, while other species need action through a lure near the surface of the body of water. Sturgeon fish, for example, feed on the bottom of the lakes and rivers where they reside. To catch a sturgeon, the bait used must be kept near the bottom of the body of water. However, many fishing leaders do not have weights at the bottom of the leader, which causes the bait and the hook to move freely throughout the water. This often results in the bait not being positioned at the bottom of the body of water. This can also lead to the leader becoming tangled in the existing fishing line. As a result, all of the aforementioned issues with fishing leaders can make it difficult for a fisherman to catch a bottom-dwelling fish such as a sturgeon.

Therefore, there exists a long-felt need in the art for an improved fishing leader device. There also exists a long-felt need in the art for a fishing leader device that keeps bait positioned near the bottom of the body of water. In addition, there exists a long-felt need in the art for a fishing leader device that provides a fast way to attach the device to an existing fishing line. Further, there exists a long-felt need in the art for a fishing leader that provides users with an easy way to tell where the leader begins and ends to further prevent breaks and knots.

The subject matter disclosed and claimed herein, in one embodiment thereof, comprises a fishing leader device. The device is comprised of a line, at least one hook, at least one weight, and at least one leader attachment member. The weight is positioned at the bottom of the leader above the hook to allow the hook and the leader to be pulled downward toward the bottom of a body of water to prevent tangles and snags. The device also is comprised of different colored lines to allow for easy distinction between the device and the fishing line. Further, the device is comprised of at least one bead that can attract fish, as well as protect the connection members from fish biting which can weaken the fastening.

In this manner, the fishing leader device of the present invention accomplishes all of the foregoing objectives and provides an improved fishing leader device. The device keeps bait positioned near the bottom of the body of water and provides a fast way to attach the device to an existing fishing line. As a result, the device allows a user to easily fish for bottom-dwelling fish like sturgeon without the risk of the leader becoming tangled in the fishing line and ultimately resulting in a line breakage.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing leader device. The device is primarily comprised of a line, at least one hook, at least one weight, and at least one leader attachment member. In the preferred embodiment, the line may be manufactured in a plurality of colors that differ from the color of a fishing line the device is attached to. This difference in color helps prevent tangles and snags because it is easily discernible where the device begins, and the fishing line ends.

The device is also comprised of at least one hook. The hook is further comprised of a tip. In one embodiment, the tip may be comprised of at least one barb that prevents the hook from backing out of a fish's mouth once the fish has been hooked. In another embodiment, the tip is angled to prevent the fish from backing off the hook. The hook is further comprised of at least one hook connection member. The hook connection member allows the line to attach to the hook and prevents the hook and the bait from detaching from the line.

The device is also comprised of at least one weight that keeps the hook positioned near the bottom of a body of water and prevents the hook from becoming tangled with the rest of the device or fishing line. In one embodiment, the weight is removable to allow the user to either add or remove weights to reach the desired weight. In this embodiment, the hook may be removed via the hook connection member and the weights can be interchanged. In another embodiment, the weights are fixed to the device. In this embodiment, the weights are not removable and cannot be interchanged.

The device is also comprised of at least one bead that helps to attract the fish to the device to have a higher chance that the fish will take the bait. The beads also function to help protect the hook connection member against damage from fish bites. In one embodiment, the beads are removable to allow a user to further customize the device by changing the colors of the beads or by replacing worn-out beads.

In addition, the device is comprised of at least one leader attachment member comprised of at least one weight, at least one line connection member, and at least one line attachment ring. The line connection member connects the fishing line to the leader attachment member. Further, the weight of the leader attachment member helps to keep the device facing downward and keeps the device from becoming tangled in the fishing line. The line attachment member is further comprised of a line attachment fastener. The line attachment fastener is preferably a ring that allows the user to tie the fishing line to the device.

Accordingly, the fishing leader device of the present invention is particularly advantageous as it provides users with an efficient way to fish for bottom-feeding fish, such as sturgeons. During use, the device provides the user with a weighted leader that helps to prevent snags and breaks in the line. In this manner, the fishing leader device overcomes the limitations of existing fishing leaders known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fishing leader device of the present invention in accordance with the disclosed architecture; and

FIG. 2 illustrates a flowchart of one potential method of using one potential embodiment of the fishing leader device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved fishing leader device. There also exists a long-felt need in the art for a fishing leader device that keeps bait positioned near the bottom of the body of water. In addition, there exists a long-felt need in the art for a fishing leader device that provides a fast way to attach the device to an existing fishing line. Further, there exists a long-felt need in the art for a fishing leader that provides users with an easy way to tell where the leader begins and ends to further prevent breaks and knots.

The present invention, in one exemplary embodiment, is comprised of a fishing leader device. The device is primarily comprised of a line, at least one hook, at least one weight, at least one bead, and a leader attachment member. The device provides a reinforced line that preferably is a different color than the fishing line, which can help prevent the lines from becoming tangled. The device is further comprised of a weight that may be removable to add more weight. The device is further comprised of at least one bead that can help attract fish, as well as protect the hook connection member.

The device is further comprised of a hook, further comprised of a hook connection member, and a tip. The hook connection member attaches the hook to the line to have a stronger fastening. The device is also comprised of a leader attachment member. The leader attachment member is comprised of at least one weight and a line connection member that attaches the leader attachment member to the line. The leader attachment member is further comprised of a line attachment fastener. The line attachment fastener connects the fishing line to the device.

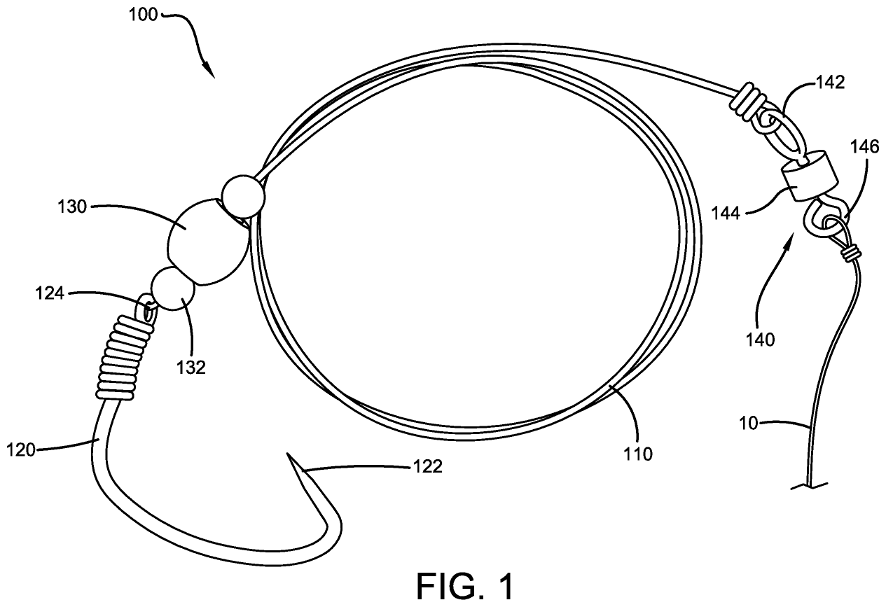

Referring initially to the drawings, FIG. 1 illustrates a perspective view of one potential embodiment of a fishing leader device 100 of the present invention in accordance with the disclosed architecture. The device 100 is primarily comprised of at least one line 110, at least one hook 120, at least one weight 130, and at least one leader attachment member 140. The device 100 is further comprised of at least one but preferably a plurality of connection members 124, 142 that provides the user with a secure fishing leader.

In the preferred embodiment, the line 110 may be manufactured from a plurality of different fishing line materials such as, but not limited to, monofilament, fluorocarbon, single-strand wire, wire braid, nylon, steel, polyethylene, polyvinylidene, etc. The line 110 may be manufactured in any length or width that is known in the art. In the preferred embodiment, the line 110 may be manufactured in a plurality of colors. The line 110 is preferably a different color than the fishing line the device 100 is used within to prevent tangles and snags by clearly indicating where the device 100 begins and the fishing line ends to allow a user to maneuver the device 100 and fishing line accordingly. There is a plurality of colors that may be used for the line 110 such as, but not limited to, blue, green, purple, yellow, orange, red, black, etc. In one embodiment, the line 110 may glow when left under sunlight for increased visibility and location of the line 110 at night.

The device 100 is also comprised of at least one hook 120. The hook 120 is preferably manufactured from a metal material such as, but not limited to, aluminum, iron, stainless steel, tin, copper, nickel, or combinations thereof. The hook 120 may be any shape or size known to one skilled in the art. The hook 120 is further comprised of at least one tip 122. In one embodiment, the tip 122 may be a barbed tip that prevents the hook 120 from backing out of a fish's mouth once the fish has been hooked. In another embodiment, the tip 122 is angled in such a way as to prevent the fish from backing off the hook 120, wherein the angle is less than or equal to 180 degrees. The hook 120 is also comprised of at least one hook connection member 124. The hook connection member 124 allows the line 110 to attach to the hook 120. The hook connection member 124 provides a strong connection that prevents the hook 120 and the bait from detaching from the line 110. The hook connection member 124 may be any fastening means known in the art such as, but not limited to, a clip, a clasp, a lock, a tie, a strap, etc.

The device 100 is also comprised of at least one weight 130. The weight 130 keeps the hook 120 positioned near the bottom of a body of water (via lack of buoyancy due to weight) and prevents the hook 120 from becoming tangled with the rest of the device 100 or fishing line 10. In the preferred embodiment, the weight 130 is in the form of a sliding sinker. In differing embodiments, the weight 130 may be any fishing weight known in the art such as, but not limited to, split-shot, rubber core sinker, worm weight, walking sinker, stationary sinker, flat sinker, coin sinker, disk sinker, no-roll sinker, pyramid sinker, dipsey sinker, bank sinker, trolling sinker, no-snag flexi weight, pencil sinker, no-snag sinker, drop-shot sinker, insert weights, hook weights, egg sinker, bullet sinker, sputnik sinker, etc.

In one embodiment, the weight 130 is removable. This allows the user to either add or remove weights 130 to reach the desired weight and buoyancy. In this embodiment, the hook 120 may be removed via the hook connection member 124 and the weights 130 can be interchanged. In another embodiment, the weights 130 are fixed to the device 100. In this embodiment, the weights 130 are not removable and cannot be interchanged.

In addition, the device 100 is comprised of at least one bead 132. The beads 132 help to attract fish to the device 100. The beads 132 may be any color known in the art to help attract the fish. The beads 132 also function to help protect the hook connection member 124. If a fish were to come and bite the hook connection member 124, it could potentially damage the line 110. The beads 132 thus protect the hook connection member 124 and protect the member 124 from damage from fish bites. The beads 132 may be manufactured from any material known in the art, but are preferably made from a plastic material such as, but not limited to: acrylic, polycarbonate, polyethylene, thermoplastic, acrylonitrile, butadiene, styrene, low density polyethylene, medium density polyethylene, high density polyethylene, polyethylene terephthalate, polyvinyl chloride, poly styrene, polylactic acid, acetal, nylon, fiberglass, biodegradable plastic, etc.

In one embodiment, the beads 132 are removable. This allows the user to either add or remove beads 132. In this embodiment, the hook 120 may be removed via the hook connection member 124 and the beads 132 can be interchanged. This allows a user to further customize the device 100 by changing the colors of the beads 132 or to replace the worn-out beads 132. In another embodiment, the beads 132 are fixed to the device 100. In this embodiment, the beads 132 are not removable and cannot be interchanged.

The device 100 may also have at least one leader attachment member 140. The leader attachment member 140 is further comprised of at least one weight 144, a line connection member 142, and a line attachment ring 146. The line connection member 142 connects the line 110 to the leader attachment member 140. The line connection member 142 may be any fastening means known in the art that will prevent the device 100 from breaking such as, but not limited to, a clip, a clasp, a lock, a tie, a strap, etc. Further, the leader attachment member 140 is comprised of at least one weight 144. The weight 144 further helps to keep the device 100 facing downward and to keep the device from becoming tangled in the fishing line. The weight 144 can be any fishing weight known in the art.

The line attachment member 140 is also comprised of at least one line attachment fastener 146. The line attachment fastener 146 is preferably a ring that allows the user to tie the fishing line 10 to the device 100. In another embodiment, the line attachment fastener 146 may be any fastener known in the art such as, but not limited to, a clip, a clasp, a lock, a tie, a strap, etc. In the preferred embodiment, the line attachment ring 146 is manufactured from a metal material such as, but not limited to, aluminum, iron, stainless steel, copper, tin, or combinations therein. In a differing embodiment, the line attachment ring 146 may be manufactured from a plastic material such as, but not limited to: acrylic, polycarbonate, polyethylene, thermoplastic, acrylonitrile, butadiene, styrene, low density polyethylene, medium density polyethylene, high density polyethylene, polyethylene terephthalate, polyvinyl chloride, poly styrene, polylactic acid, acetal, nylon, fiberglass, biodegradable plastic, etc.

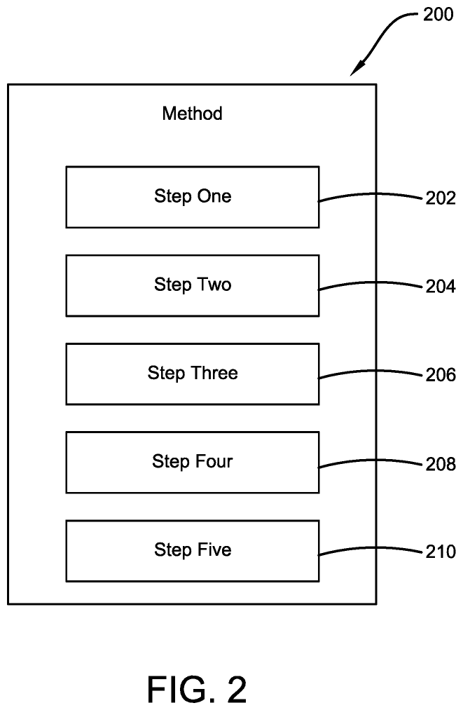

FIG. 2 illustrates a flowchart of one potential method 200 of using one potential embodiment of the fishing leader device 100 of the present invention in accordance with the disclosed architecture. First, a user attaches the device 100 to a fishing line via the line attachment fastener 146 [Step 202]. Then, a user can add any beads 132 and weights 130 to the line 110 that the user wishes to use [Step 204]. Next, the user attaches the hook 120 to the line 110 via the hook connection member 124 [Step 206]. Then, the user places the desired bait onto the tip 122 of the hook 120 [Step 208]. Finally, when the user casts the device 100 out into the water, the weight 130 will cause the device 100 to stay toward the bottom of the lake/river to optimize the probability of catching a sturgeon or other fish [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing leader device” and “device” are interchangeable and refer to the fishing leader device 100 of the present invention.

Notwithstanding the foregoing, the fishing leader device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fishing leader device 100 as shown in the FIGS. are for illustrative purposes only, and that many other sizes and shapes of the fishing leader device 100 are well within the scope of the present disclosure. Although the dimensions of the fishing leader device 100 are important design parameters for user convenience, the fishing leader 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fishing leader device comprising:
a line;
a hook;
a weight; and
a leader attachment member.

2. The fishing leader device of claim 1, wherein the hook is comprised of a tip.

3. The fishing leader device of claim 2, wherein the tip is comprised of a barbed tip.

4. The fishing leader device of claim 1, wherein the line is comprised of a monofilament, a fluorocarbon, a single-strand wire, a wire braid, a nylon, a steel, a polyethylene or a polyvinylidene line.

5. The fishing leader device of claim 1, wherein the weight is positioned above the hook.

6. The fishing leader device as recited in claim 1 further comprised of a bead.

7. The fishing leader device of claim 6, wherein the bead is positioned above the hook.

8. The fishing leader device of claim 6, wherein the bead is comprised of a colored bead.

9. A fishing leader device comprising:
a line;
a hook attached to the line via a hook connection member;
a weight;
a bead; and
a leader attachment member.

10. The fishing leader device of claim 9, wherein the leader attachment member is comprised of a weight.

11. The fishing leader device of claim 10, wherein the leader attachment member is comprised of a line attachment fastener that connects a fishing line to the fishing leader device.

12. The fishing leader device of claim 11, wherein the line attachment fastener is comprised of a ring.

13. The fishing leader device of claim 10, wherein the leader attachment member is comprised of a line connection member that attaches the leader attachment member to the line.

14. The fishing leader device of claim 9, wherein the hook is comprised of a hook connection member that fastens the hook to the line.

15. The fishing leader device of claim 9, wherein the line is comprised of a colored line.

16. The fishing leader device of claim 9, wherein the weight is comprised of a sliding sinker, a split-shot, a rubber core sinker, a worm weight, a walking sinker, a stationary sinker, a flat sinker, a coin sinker, a disk sinker, a no-roll sinker, a pyramid a sinker, a dipsey sinker, a bank sinker, a trolling sinker, a no-snag flexi weight, a pencil sinker, a no-snagg sinker, a drop-shot sinker, an insert weights, a hook weights, an egg sinker, a bullet sinker or a sputnik sinker.

17. The fishing leader device of claim 9, wherein the weight and the bead are removably attachable to the fishing leader device.

18. The fishing leader device of claim 9, wherein the hook is comprised of a metal material.

19. The fishing leader device of claim 9, wherein the hook is comprised of an angled tip that forms an angle that is less than 180 degrees.

20. The method of using a fishing leader device, the method comprising the steps of:
attaching the fishing leader device to a fishing line via a line attachment fastener of a fishing leader device;
securing a weight and a bead to a line of the fishing leader device and attaching a hook to the line via a hook connection member; and
casting the fishing line into a body of water.
